(19) United States
(12) Patent Application Publication
(10) Pub. No.: US 2012/0035940 A1
(43) Pub. Date: Feb. 9, 2012

(54) AUDIO SIGNAL PROCESSING METHOD, ENCODING APPARATUS THEREFOR, AND DECODING APPARATUS THEREFOR

(75) Inventors: Jong-hoon JEONG, Suwon-si (KR); Nam-suk LEE, Suwon-si (KR); Han-gil MOON, Seoul (KR)

(73) Assignee: SAMSUNG ELECTRONICS CO., LTD., Suwon-si (KR)

(21) Appl. No.: 13/204,198

(22) Filed: Aug. 5, 2011

Related U.S. Application Data
(60) Provisional application No. 61/371,294, filed on Aug. 6, 2010.

(30) Foreign Application Priority Data
Jul. 13, 2011 (KR) 10-2011-0069495

(51) Int. Cl. G10L 19/00

(52) U.S. Cl. 704/500; 704/E19.001

(57) ABSTRACT

An audio signal processing method includes: receiving an audio signal comprising consecutive frames; generating a first encoding parameter corresponding to a first frame among the consecutive frames and a second encoding parameter corresponding to a second frame adjacent to the first frame; and generating at least one interpolated parameter based on the first encoding parameter and the second encoding parameter.

### CROSS-REFERENCE TO RELATED PATENT APPLICATION

This application claims the benefit of U.S. Provisional Application No. 61/371,294 filed on Aug. 6, 2010, and Korean Patent Application No. 10-2011-0069495, filed on Jul. 13, 2011 in the Korean Intellectual Property Office, the disclosures of which are incorporated herein in their entirety by reference.

### BACKGROUND

1. Field

Methods and apparatuses consistent with exemplary embodiments relateto an audio signal processing method, an encoding apparatus therefor, and a decoding apparatus therefor, and more particularly, to an audio signal processing method of generating encoding parameters and an encoding apparatus therefor, and an audio signal processing method of generating interpolated frames by using encoding parameters, and a decoding apparatus therefor.

2. Description of the Related Art

To compress and transmit an audio signal including a plurality of frames, receive the compressed audio signal, and restore the original audio signal, an encoder is used in a transmission end, and a decoder is used in a reception end. The transmission end and the reception end compress and restore, respectively, an audio signal in accordance with a predetermined standard.

The encoder extracts a predetermined parameter from each frame during a process of compressing an audio signal. In this regard, the predetermined parameter is a parameter value used to receive the compressed audio signal in the decoder and restore the received audio signal to the original audio signal. The predetermined parameter is hereinafter referred to as an encoding parameter.

The encoding parameter may be generated in a frame unit. The encoder analyzes one frame that is an audio signal reproduced for a predetermined period of time, and generates a single encoding parameter.

A single frame has the same value of encoding parameters. Therefore, if a sound image changes in a single frame, an audio signal reflecting such a change cannot be output. In this regard, the sound image indicates a point perceived by a user as a location where sound is produced.

Therefore, if a sound image formed in a single frame is greatly different from a sound image formed in an adjacent frame, the user perceives unnatural sound. Accordingly, an audio signal processing method and an apparatus therefor are necessarily provided to reproduce naturally connected sound and enhance audio quality.

### SUMMARY OF THE INVENTION

One or more exemplary embodiments provide an audio signal processing method capable of generating interpolated frames located between originals frames, an encoding apparatus therefor, and a decoding apparatus therefor.

More specifically, one or more exemplary embodiments provide an audio signal processing method capable of reproducing naturally connected sound, an encoding apparatus therefor, and a decoding apparatus therefor. Furthermore, one or more exemplary embodiments provide an audio signal processing method capable of enhancing audio quality, an encoding apparatus therefor, and a decoding apparatus therefor.

According to an aspect of an exemplary embodiment, there is provided an audio signal processing method including: receiving an audio signal including consecutive frames; generating a first encoding parameter corresponding to a first frame among the consecutive frames and a second encoding parameter corresponding to a second frame adjacent to the first frame; and generating at least one interpolated parameter by using the first encoding parameter and the second encoding parameter.

The at least one interpolated parameter may be an encoding parameter used to generate at least one interpolated frame located between a third frame decoded by using the first encoding parameter and a fourth frame decoded by using the second encoding parameter.

The generating of the at least one interpolated parameter may include generating the at least one interpolated parameter by using a first predetermined value obtained by applying a first weight to the first encoding parameter and a second predetermined value obtained by applying a second weight to the second encoding parameter.

The generating of the at least one interpolated parameter may further include generating the at least one interpolated parameter by using a value obtained by summing the first predetermined value obtained by multiplying the first weight and the first encoding parameter and the second predetermined value obtained by multiplying the second weight and the second encoding parameter.

The first weight may be inversely proportional to the second weight.

A sum of the first weight and the second weight may be 1.

The method may further include: generating a bit stream corresponding to the audio signal and including the first encoding parameter, the second encoding parameter, and the at least one interpolated parameter; and transmitting the bit stream from an encoding apparatus to a decoding apparatus.

The method may further include: receiving the transmitted bit stream at the decoding apparatus and de-formatting the received bit stream; and extracting the first encoding parameter, the second encoding parameter, and the at least one interpolated parameter from the de-formatted bit stream.

The method may further include generating the at least one interpolated frame located between the third frame and the fourth frame by using the at least one interpolated parameter.

The generating of the at least one interpolated frame may include generating n interpolated frames.

The generating a first encoding parameter and a second encoding parameter may include applying an analysis window having a length L to the consecutive frames, and extracting the first encoding parameter and the second encoding parameter in a unit of frame data included in the analysis window, and generating at least one interpolated frame may include adjusting a size of a synthesis window according to the number n of the at least one interpolated parameter, and generating the n interpolated frames by using the synthesis window having the adjusted size.

The encoding parameter may include at least one of an inter-channel intensity difference (IID) parameter, an inter-channel phase difference (IPD) parameter, an overall phase difference (OPD) parameter, and an inter-channel coherence (ICC) parameter.

According to an aspect of another exemplary embodiment, there is provided an encoding apparatus including: an analysis filter bank which receives an audio signal including consecutive frames, and generates a first encoding parameter corresponding to a first frame among the consecutive frames and a second encoding parameter corresponding to a second frame adjacent to the first frame; an encoding unit which generates at least one interpolated parameter by using the first encoding parameter and the second encoding parameter; and a formatter which generates a bit stream including the first encoding parameter, the second encoding parameter, and the at least one interpolated parameter.

According to an aspect of another exemplary embodiment, there is provided a decoding apparatus including: a de-formatter which receives a bit stream including a first encoding parameter, a second encoding parameter, and at least one interpolated parameter, and de-formats and outputs the bit stream; a decoding unit which extracts the first encoding parameter, the second encoding parameter, and the at least one interpolated parameter from the bit stream; and a synthesis filer bank which generates a first frame and a second frame by using the first encoding parameter and the second encoding parameter, and generates at least one interpolated frame located between the first frame and the second frame by using the at least one interpolated parameter.

### BRIEF DESCRIPTION OF THE DRAWINGS

The above and other aspects will become more apparent by describing in detail exemplary embodiments with reference to the attached drawings in which:

FIG. 1 is a block diagram of an encoding apparatus according to an exemplary embodiment;

FIG. 2 is a flowchart illustrating an audio signal processing method according to an exemplary embodiment;

FIG. 3 is a diagram for explaining the audio signal processing method of FIG. 2 according to an exemplary embodiment;

FIG. 4 is a graph for explaining weight values used in an operation of generating at least one interpolated parameter of FIG. 2;

FIG. 5 is a block diagram of a decoding apparatus according to an exemplary embodiment;

FIG. 6 is a flowchart illustrating an audio signal processing method according to another exemplary embodiment;

FIG. 7 is a diagram for explaining operations of extracting first and second encoding parameters and at least one interpolated parameter and generating first and second frames and at least one interpolated frame of FIG. 6;

FIGS. 8A through 8C are diagrams for explaining interpolated parameters, interpolated frames, and an audio signal according to an exemplary embodiment; and

FIGS. 9A through 9C are diagrams for explaining interpolated parameters, interpolated frames, and an audio signal according to another exemplary embodiment.

### DETAILED DESCRIPTION OF THE INVENTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout. In this detailed description, the term “unit” denotes a hardware component and/or a software component that is executed by a hardware component such as a processor.

FIG. 1 is a block diagram of an encoding apparatus 100 according to an exemplary embodiment.

Referring to FIG. 1, the encoding apparatus 100 of the exemplary embodiment includes an analysis filter bank 120, a formatter 125, and an encoding unit 130.

The analysis filter bank 120 receives an audio signal including consecutive frames. The analysis filter bank 120 generates a first encoding parameter corresponding to a first frame of the consecutive frames and a second encoding parameter corresponding to a second frame adjacent to the first frame. In this regard, the second frame may be adjacent to a previous end of the first frame. For example, if the first frame is an (n+1)^{th} frame at a predetermined point, the second frame may be an n^{th} frame that is a previous frame. The second frame also may be adjacent to a subsequent end of the first frame. For example, if the first frame is an n^{th} frame at a predetermined point, the second frame may be the (n+1)^{th} frame that is a subsequent frame.

The encoding parameter is used to restore a predetermined audio signal corresponding to a predetermined channel in a decoding apparatus. More specifically, the encoding parameter is used to decode frames included in a predetermined audio signal.

The encoding parameter may include a multi-channel parameter that up-mixes a received and compressed audio signal and generates audio signals corresponding to multi-channels.

The encoding parameter may include at least one of an inter-channel intensity difference (IID) parameter, an inter-channel phase difference (IPD) parameter, an overall phase difference (OPD) parameter, and an inter-channel coherence (ICC) parameter.

The encoding unit 130 generates at least one interpolated parameter by using the first encoding parameter and the second encoding parameter. The analysis filter bank 120 may generate the at least one interpolated parameter, or a system controller (not shown) included in the encoding apparatus 100 may generate the at least one interpolated parameter.

The formatter 125 generates a bit stream including the first encoding parameter and the second encoding parameter and the at least one interpolated parameter generated by the analysis filter bank 120. More specifically, the formatter 125 may generate the bit stream in accordance with a predetermined standard, for example but not limited to, the MP3 standard. The formatter 125 may transmit the bit stream to the decoding apparatus.

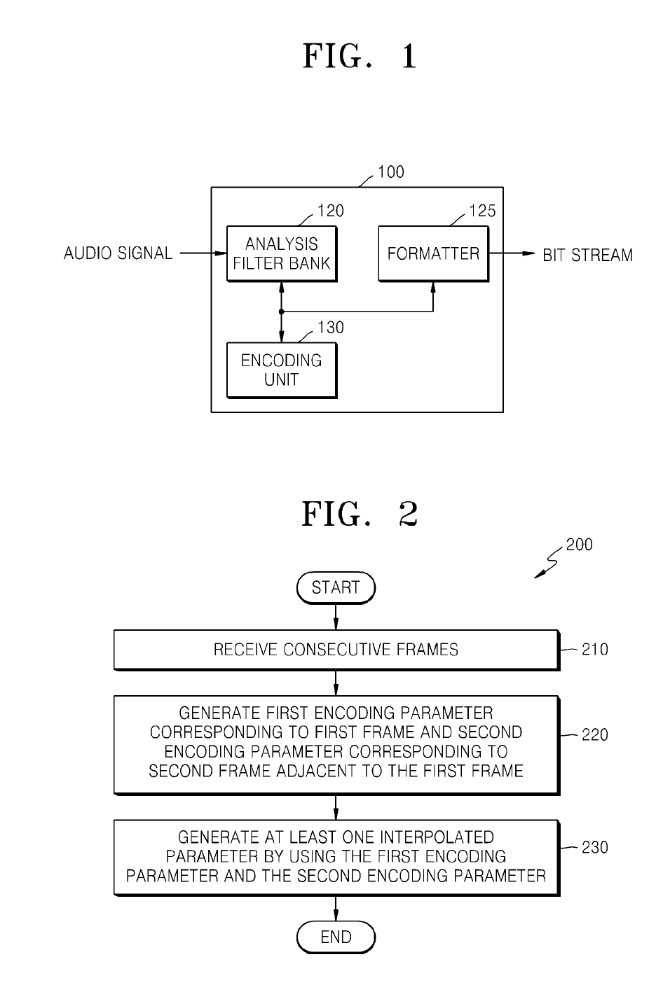

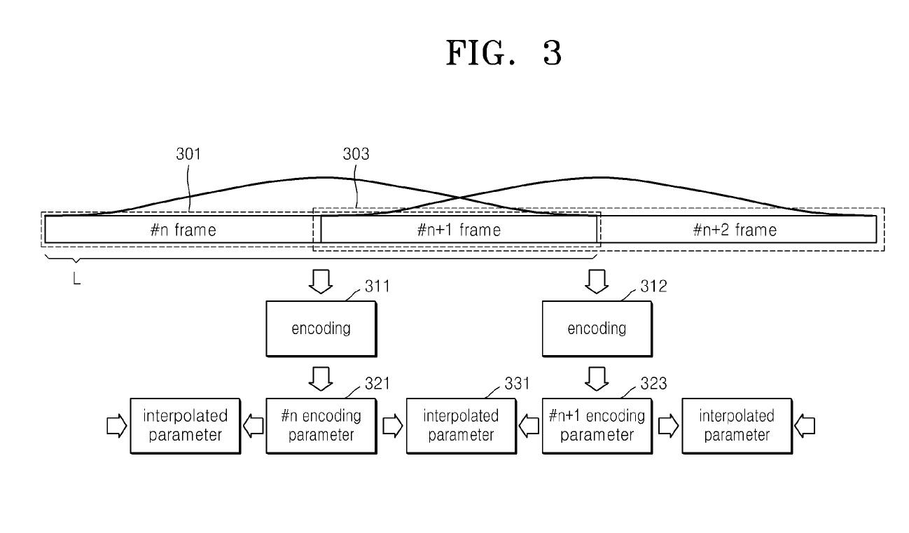

The operations of the elements of the encoding apparatus 100 of the present embodiment are similar to operations of an audio signal processing method according to the present inventive concept in terms of the technical idea. Therefore, the operation of the encoding apparatus 100 of the exemplary embodiment will be described in detail with reference to FIGS. 2 through 4 relating to the audio signal processing method according to the present inventive concept. The redundant descriptions therebetween will not be repeated here.

FIG. 2 is a flowchart illustrating an audio signal processing method 200 according to an exemplary embodiment. The audio signal processing method 200 of the exemplary embodiment may be performed in an encoding apparatus according to the present inventive concept.

FIG. 3 is a diagram for explaining the audio signal processing method 200 of FIG. 2 according to an exemplary embodiment. The audio signal processing method 200 will now be described with reference to FIGS. 1 through 3.

Referring to FIG. 2, the audio signal processing method 200 receives an audio signal including consecutive frames (operation 210). Operation 210 may be performed by the analysis filter bank 120.

In this regard, the consecutive frames may overlap by 50% and be encoded in order to prevent discontinuity between frames. More specifically, as shown in FIG. 3, a half of a first frame 301 and a second frame 303 subsequent to the first frame 301 overlap and are input, and encoding operations 311 and 312 are performed on the input first and second frames 301 and 303, respectively. Referring to FIG. 3, the first frame 301 is an n^{th} frame #n frame at a predetermined point, and the second frame 303 is an (n+1)^{th} frame #n+1 frame subsequent to the n^{th} frame #n frame.

A first encoding parameter 321 corresponding to the first frame 301 and a second encoding parameter 323 corresponding to the second frame 303 adjacent to the first frame 301 are generated among the consecutive frames included in the input audio signal (operation 220). More specifically, a predetermined encoding parameter may be generated by applying an analysis window corresponding to the length L of the first frame 301 and using frame data of the analysis window.

In this regard, operation 220 may be performed by the analysis bank filter 120. The first encoding parameter 321 and the second encoding parameter 323 may be extracted and generated during an operation of encoding the audio signal. Thus, in FIG. 3, the first encoding parameter 321 and the second encoding parameter 323 may be generated in operations 311 and 312 of encoding the input first and second frames 301 and 303.

At least one interpolated parameter 331 is generated by using the first encoding parameter 321 and the second encoding parameter 323 generated in operation 220 (operation 230). FIG. 3 shows an example of generating the at least one interpolated parameter 331 by using the first encoding parameter 321 and the second encoding parameter 323. As described above, operation 230 may be performed by the encoding unit 130. As described above, operation 230 may be performed by the analysis filter bank 120 or a system controller (not shown) included in the encoding apparatus 100.

In this regard, the at least one interpolated parameter 331 is an encoding parameter used to generate at least one interpolated frame located between a third frame decoded by using the first encoding parameter 321 and a fourth frame decoded by using the second encoding parameter 323.

In operation 230, the at least one interpolated parameter 331 may be generated by using a first predetermined value obtained by applying a first weight to the first encoding parameter 321 and a second predetermined value obtained by applying a second weight to the second encoding parameter 323.

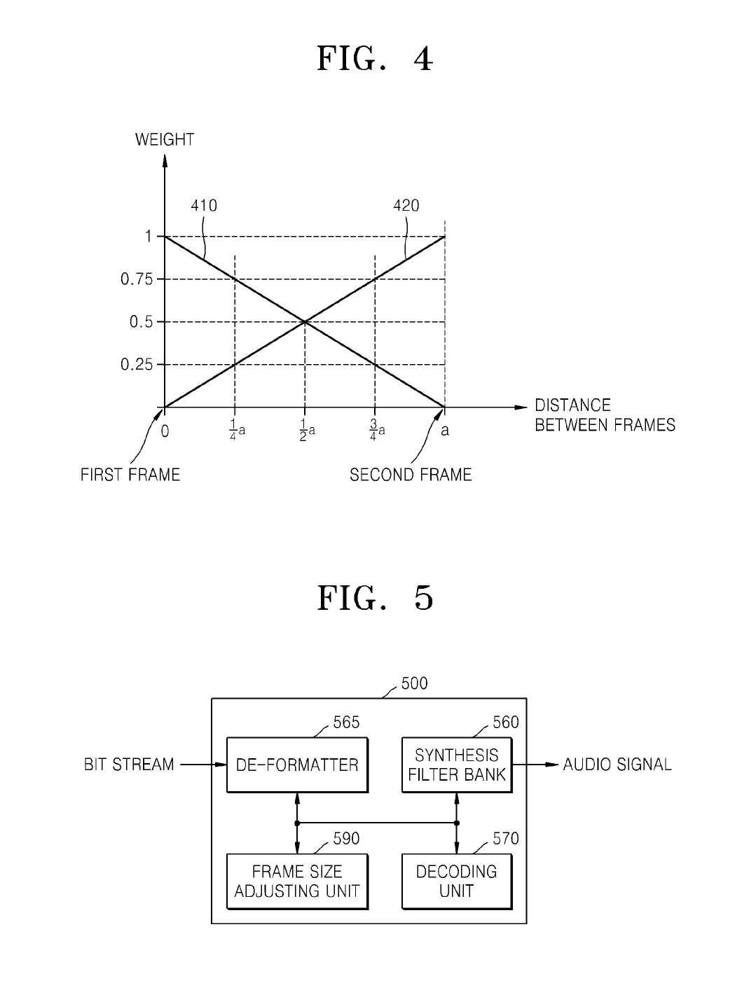

FIG. 4 is a graph for explaining weight values used in operation 230 of FIG. 2.

Referring to FIG. 4, a line 410 indicates a value of a first weight Wk1 used to generate the interpolated parameter 331, and a line 420 indicates a value of a second weight Wk2 used to generate the interpolated parameter 331. The X axis indicates a distance between frames. The Y axis indicates values of the first weight Wk1 and the second weight Wk2. More specifically, if the interpolated parameter 331 is generated between a third frame decoded by using the first encoding parameter 321 and a fourth frame decoded by using the second encoding parameter 323, the interpolated parameter 331 may be located at a point a/2 that is a middle point of the third frame and the fourth frame (not shown).

The line 410 indicating the value of the first weight Wk1 applied to the first encoding parameter 321 may be in inverse proportional to the line 420 indicating the value of the second weight Wk2 applied to the second encoding parameter 323. Further, a sum of the first weight Wk1 and the second weight Wk2 may be 1.

More specifically, the interpolated parameter 331 may be defined according to Equation 1 below.

Pk=Wk1*Pn+Wk2*(Pn+1) [Equation 1]

In Equation 1, Pk denotes the interpolated parameter 331, Pn denotes the first encoding parameter 321, (Pn+1) denotes the second encoding parameter 323, Wk1 denotes the first weight applied to the first encoding parameter Pn 321, and Wk2 denotes the second weight applied to the second encoding parameter Pn+1 323.

Referring to Equation 1, the interpolated parameter Pk 331 may be a sum of a first predetermined value (Wk1*Pn) obtained by multiplying the first weight Wk1 and the first encoding parameter Pn 321 and a second predetermined value (Wk2*(Pn+1)) obtained by multiplying the second weight Wk2 and the second encoding parameter Pn+1 323.

For example, if an interpolated frame is generated between the third frame and the fourth frame, the interpolated frame may be located between the third frame and the fourth frame. Thus, the interpolated frame may be located at the point a/2 where the first weight Wk1 and the second weight Wk2 may have values 0.5 and 0.5, respectively. Therefore, the interpolated parameter Pk 331 may be set as a value 0.5*Pn+0.5*(Pn+1).

If n interpolated frames are generated between the third frame and the fourth frame, the n interpolated frames may be disposed having the same gap between the third frame and the fourth frame.

If first, second, and third interpolated frames in which n=3 are generated between the third frame and the fourth frame, for example, the first, second, and third interpolated frames Pk1, Pk2, and Pk3 may be located at points a/4, a/2, and 3a/4, respectively. In this case, the first and second weights Wk1 and Wk2 used to generate the second interpolated frame Pk2 may be 0.5 and 0.5, respectively. The first and second weights Wk1 and Wk2 used to generate the third interpolated frame Pk3 may be 0.25 and 0.75, respectively.

As described above, the closer to the third frame the interpolated frame, the greater the value of the first weight Wk1 applied to the first encoding parameter Pn 321. The closer to the fourth frame the interpolated frame, the greater the value of the second weight Wk2 applied to the second encoding parameter Pn+1 323.

FIG. 5 is a block diagram of a decoding apparatus 500 according to an exemplary embodiment.

Referring to FIG. 5, the decoding apparatus 500 of the exemplary embodiment includes a synthesis filter bank 560, a de-formatter 565, and a decoding unit 570. The decoding apparatus 500 receives the bit stream generated and transmitted from the encoding apparatus 100 of FIG. 1, decodes the received bit stream, and generates audio signals corresponding to at least one channel.

The de-formatter 565 receives the bit stream including first and second encoding parameters and at least one interpolated parameter from the encoding apparatus 100, de-formats the bit stream, and outputs the bit stream. More specifically, the formatter 125 of the encoding apparatus 100 formats and outputs an encoded audio signal, and thus the de-formatter 565 converts a format of the bit stream so that the bit stream has a same format as before being formatted by the formatter 125.

The decoding unit 570 decodes the received bit stream in accordance with a predetermined standard. The decoding unit 570 extracts the first and second encoding parameters and the at least one interpolated parameter from the decoded bit stream.

The synthesis filter bank 560 generates first and second frames by using the first and second encoding parameters, and generates at least one interpolated frame located between the first and second frames by using the at least one interpolated parameter.

The decoding apparatus 500 may further include a frame size adjusting unit that adjusts a size of a synthesis window according to the number of interpolated parameters. The adjustment of the size of the synthesis window according to the number of interpolated parameters may be performed by the synthesis filter bank 560 or the decoding unit 570.

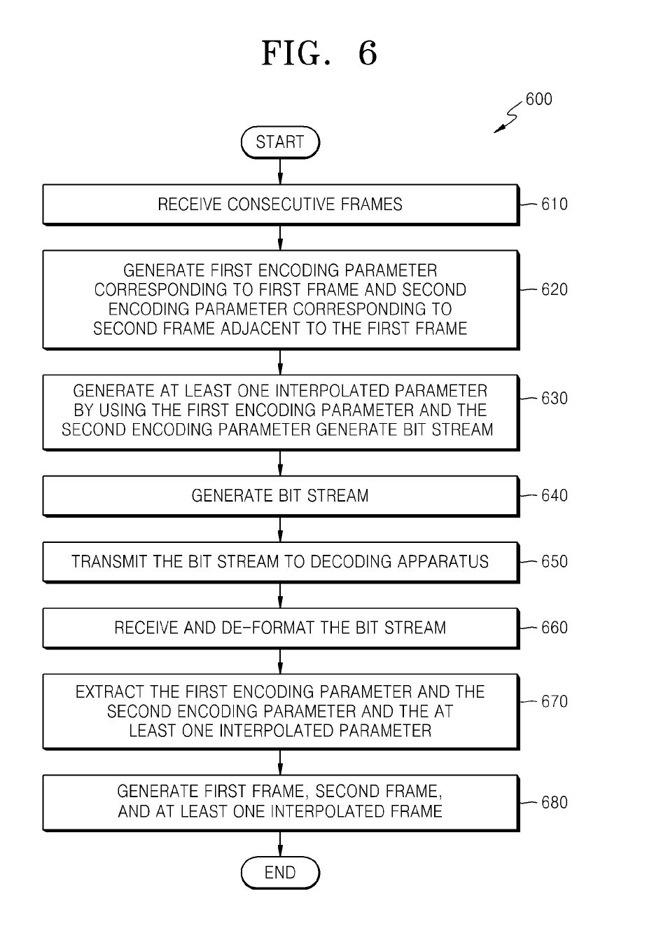

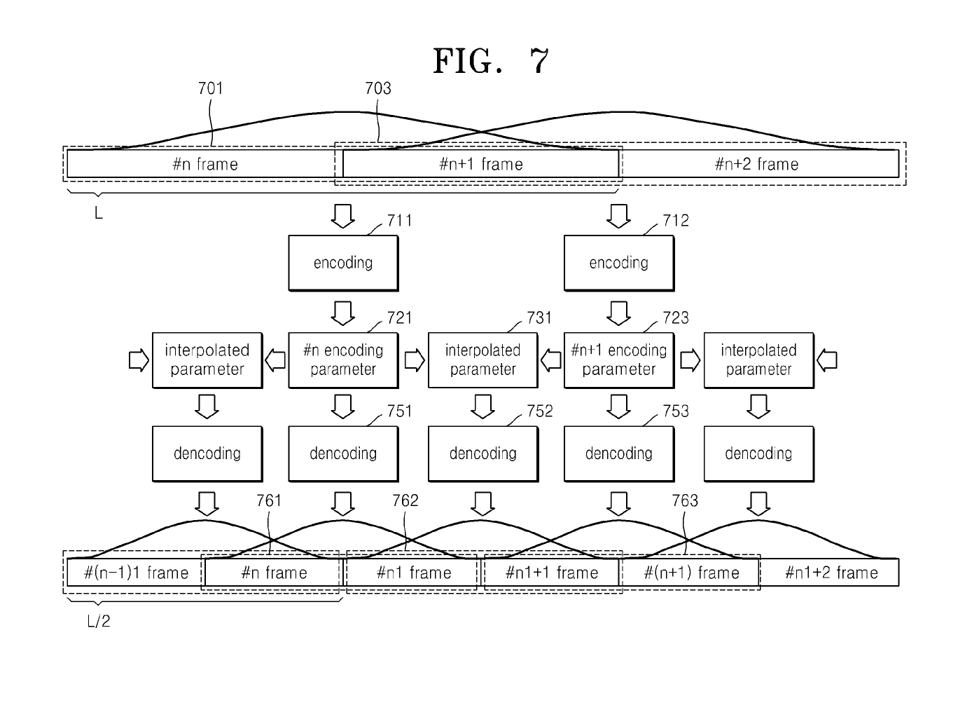

The operations of the elements of the decoding apparatus 500 of the exemplary embodiment are similar to operations of an audio signal processing method that will be described with reference to FIGS. 6 and 7 below in terms of the technical idea. Therefore, the operation of the encoding apparatus 500 of the exemplary embodiment will be described in detail with reference to FIGS. 6 and 7 relating to the audio signal processing method according to another exemplary embodiment. The redundant descriptions between FIGS. 5 and 7 will not be repeated here.

FIG. 6 is a flowchart illustrating an audio signal processing method 600 according to another exemplary embodiment.

Operations 610, 620, and 630 of FIG. 6 are the similar to operations 210, 220, and 230 of FIG. 2, respectively, and thus descriptions thereof will not be repeated here. The audio signal processing method 600 may further include at least one of operations 640, 650, 660, 670, and 680, compared to the audio signal processing method 200 of FIG. 2.

Subsequent to operation 630, a bit stream including the first and second encoding parameters and the at least one interpolated parameter generated by the encoding unit 130 is generated (operation 640).

The bit stream generated in operation 640 is transmitted to the decoding apparatus 500. Accordingly, the de-formatter 565 of the decoding apparatus 500 receives the bit stream including the first and second encoding parameters and the at least one interpolated parameter.

Operations 640 and 650 may be performed by the formatter 125 of the encoding apparatus 100.

The decoding apparatus 500 receives the transmitted bit stream and de-formats the received bit stream (operation 660). Operation 660 may be performed by the de-formatter 565. More specifically, in operation 660, a format of the bit stream is converted so that the bit stream has a same format as before being formatted by the formatter 125.

Operations 670 and 680 will now be described in detail with reference to FIG. 7.

FIG. 7 is a diagram for explaining operations 670 and 680 of FIG. 6.

Referring to FIG. 7, first and second frames 701 and 703 correspond to the first and second frames 301 and 303 of FIG. 3, respectively. Encoding operations 711 and 712, first and second encoding parameters 721 and 723, and interpolated parameter 731 correspond to the encoding operations 311 and 312, the first and second encoding parameters 321 and 323, and the interpolated parameter 331 of FIG. 3, respectively. Thus, redundant descriptions between FIGS. 3 and 7 will be omitted here.

The first and second encoding parameters and the at least one interpolated parameter are extracted from the bit stream de-formatted in operation 660 (operation 670). More specifically, the bit stream received in the decoding apparatus 500 is decoded 751, 752, and 753, and the first and second encoding parameters and the at least one interpolated parameter may be extracted or generated.

Operation 670 may be performed by the decoding unit 570. Alternatively, operation 670 may be performed by a system controller (not shown) or the synthesis filter bank 560 included in the decoding apparatus 500. In this regard, the at least one interpolated parameter may be n interpolated parameters.

At least one interpolated frame located in a third frame 761 and a fourth frame 763 is generated by using the at least one interpolated parameter extracted in operation 670 (operation 680). Operation 680 may be performed by the synthesis filter bank 560.

A synthesis window may be used to generate a plurality of frames included in an original audio signal. The synthesis window defines a length of an audio frame decoded and output by the decoding apparatus 500.

In FIG. 7, the number n of interpolated frames located between the third frame 761 and the fourth frame 763 is 1. The size of the synthesis window may be adjusted according to the number n of the interpolated parameters or the number n of interpolated frames to be generated. More specifically, as shown in FIG. 7, when the number of the interpolated parameters is 1, the size of the synthesis window may be L/2. In this regard, L denotes the size of the analysis window described above.

Referring to FIG. 7, the third frame #n frame 761 corresponding to the first frame #n frame 701 is generated by using the first encoding parameter 721. An interpolated frame #n1 frame 762 is generated by using the interpolated parameter 731. The fourth frame #n+1 frame 763 corresponding to the second frame #n+1 frame 703 is generated.

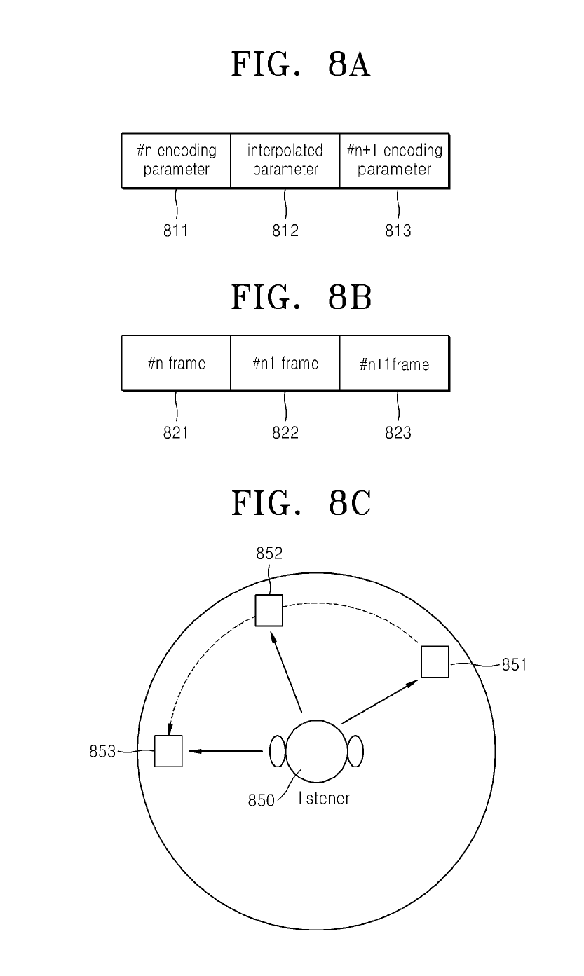

FIGS. 8A through 8C are diagrams for explaining interpolated parameters, interpolated frames, and an audio signal according to an exemplary embodiment.

Referring to FIG. 8A, an interpolated parameter 812 is generated. More specifically, a first encoding parameter 811, a second encoding parameter 813, and the interpolated parameter 812 may correspond to the first encoding parameter 721, the second encoding parameter 723, and the interpolated parameter 731 of FIG. 7, respectively.

Referring to FIG. 8B, a third frame 821, a fourth frame 823, and an interpolated frame 822 are decoded corresponding to the first encoding parameter 811, the second encoding parameter 813, and the interpolated parameter 812 of FIG. 8A, respectively.

The third frame 821, the fourth frame 823, and the interpolated frame 822 correspond to the third frame #n frame 761, the fourth frame #n+1 frame 763, and the interpolated frame #n1 frame 762 of FIG. 7, respectively.

Referring to FIG. 8C, if an interpolated frame is generated, a sound image output according to the interpolated frame changes.

If an audio signal corresponding to the third frame 821 that is decoded by using the first encoding parameter 811 is output, a listener 850 perceives a sound image located at a point 851. If an audio signal corresponding to the fourth frame 823 that is decoded by using the second encoding parameter 813 is output, the listener 850 perceives a sound image located at a point 853.

When a location of a sound image corresponding to two adjacent frames that are continuously output rapidly changes from the point 851 to the point 853 in an audio signal processing method and a decoding apparatus, a user who is a listener perceives the rapidly changing sound image and accordingly listens to unnatural sound.

The interpolated parameter 812 is used to generate the interpolated frame 822. If an audio signal corresponding to the interpolated frame 822 is output, the listener 850 perceives a sound image located at a point 852.

Therefore, the audio signal processing method, the encoding apparatus, and the decoding apparatus according to the present inventive concept can reproduce naturally connected audio signals, thereby allowing a user to perceive naturally connected sound images and enhancing quality of audio perceived by the user.

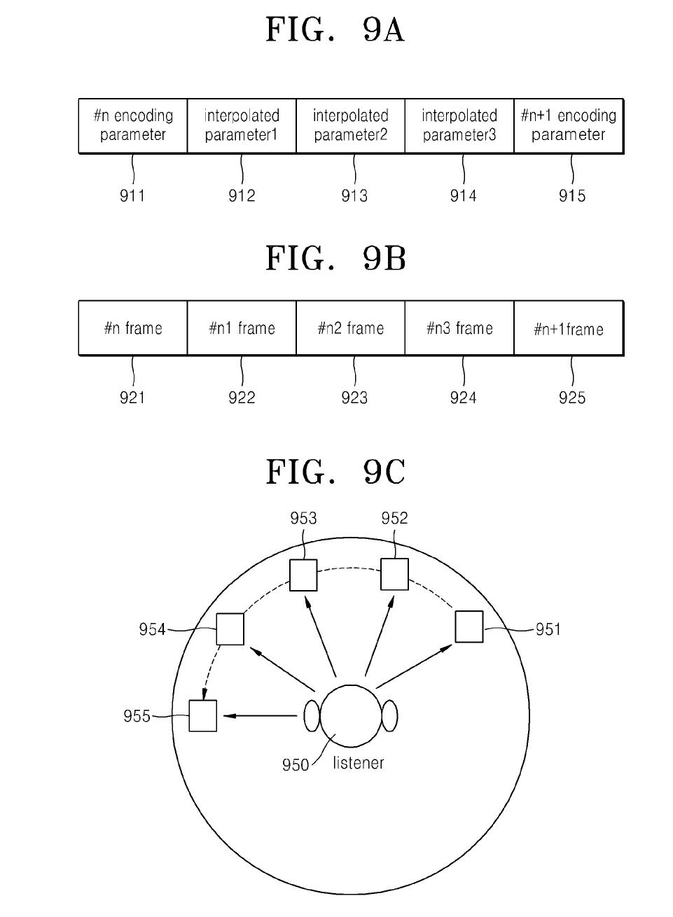

FIGS. 9A through 9C are diagrams for explaining interpolated parameters, interpolated frames, and an audio signal according to another exemplary embodiment.

Referring to FIG. 9A, three interpolated parameters 912, 913, and 914 are generated. More specifically, a first encoding parameter 911 and a second encoding parameter 915 may correspond to the first encoding parameter 721 and the second encoding parameter 723 of FIG. 7, respectively.

Weight values used to generate the three interpolated parameters 912, 913, and 914 may be set according to the weight values shown in FIG. 4.

Referring to FIG. 9B, a third frame 921, a fourth frame 925, and interpolated frames 922, 923, and 924 are decoded corresponding to the first encoding parameter 911, the second encoding parameter 915, and the interpolated parameters 912, 913, and 914 of FIG. 9A, respectively.

The third frame 921 and the fourth frame 925 correspond to the third frame #n frame 761, and the fourth frame #n+1 frame 763 of FIG. 7, respectively.

Referring to FIG. 9C, if three interpolated frames are generated, a sound image output according to the interpolated frames changes.

If an audio signal corresponding to the third frame 921 that is decoded by using the first encoding parameter 911 is output, a listener 950 perceives a sound image located at a point 951.

If audio signals corresponding to the interpolated frames 922, 923, and 924 that are decoded by using the interpolated parameters 912, 913, and 914 are output, the listener 850 continuously perceives sound images located at points 952, 953, and 954.

If an audio signal corresponding to the fourth frame 925 that is decoded by using the second encoding parameter 915 is output, the listener 950 perceives a sound image located at a point 955.

If the number of interpolated frames generated between two adjacent frames increases, the user can perceive more naturally sound images.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present inventive concept has been particularly shown and described with reference to exemplary embodiments thereof, it will be understood by those of ordinary skill in the art that various changes in form and details may be made therein without departing from the spirit and scope of the present inventive as defined by the following claims.

What is claimed is:

1. An audio signal processing method comprising:
receiving an audio signal comprising consecutive frames;
generating a first encoding parameter corresponding to a first frame among the consecutive frames and a second encoding parameter corresponding to a second frame among the consecutive frames, wherein the second frame is adjacent to the first frame; and
generating at least one interpolated parameter based on the first encoding parameter and the second encoding parameter.

2. The method of claim 1, wherein the at least one interpolated parameter is an encoding parameter to generate at least one interpolated frame located between a third frame decoded based on the first encoding parameter and a fourth frame decoded based on the second encoding parameter.

3. The method of claim 2, wherein the generating at least one interpolated parameter comprises generating the at least one interpolated parameter based on a first predetermined value obtained by applying a first weight to the first encoding parameter and a second predetermined value obtained by applying a second weight to the second encoding parameter.

4. The method of claim 3, wherein the generating the at least one interpolated parameter further comprises generating the at least one interpolated parameter based on a value obtained by summing the first predetermined value obtained by multiplying the first weight and the first encoding parameter and the second predetermined value obtained by multiplying the second weight and the second encoding parameter.

5. The method of claim 3, wherein the first weight is inversely proportional to the second weight.

6. The method of claim 5, wherein a sum of the first weight and the second weight is 1.

7. The method of claim 2, further comprising:
generating a bit stream corresponding to the audio signal, the bit stream comprising the first encoding parameter, the second encoding parameter, and the at least one interpolated parameter; and
transmitting the bit stream from an encoding apparatus to a decoding apparatus.

8. The method of claim 7, further comprising:
receiving the transmitted bit stream at the decoding apparatus and de-formatting the received bit stream; and
extracting the first encoding parameter, the second encoding parameter, and the at least one interpolated parameter from the de-formatted bit stream.

9. The method of claim 2, further comprises generating the at least one interpolated frame located between the third frame and the fourth frame based on the at least one interpolated parameter.

10. The method of claim 9, wherein the generating the at least one interpolated frame comprises generating n interpolated frames.

11. The method of claim 10, wherein the generating the first encoding parameter and the second encoding parameter comprises:
applying an analysis window having a length L to the consecutive frames, and
extracting the first encoding parameter and the second encoding parameter in a unit of frame data included in the analysis window, and
wherein the generating the at least one interpolated frame comprises:
adjusting a size of a synthesis window according to the number n of the at least one interpolated parameter, and
generating the n interpolated frames based on the synthesis window having the adjusted size.

12. The method of claim 2, wherein the encoding parameter comprises at least one parameter selected from the group of consisting of an inter-channel intensity difference (IID) parameter, an inter-channel phase difference (IPD) parameter, an overall phase difference (OPD) parameter, and an inter-channel coherence (ICC) parameter.

13. An encoding apparatus comprising:
an analysis filter bank which receives an audio signal comprising consecutive frames, and generates a first encoding parameter corresponding to a first frame among the consecutive frames and a second encoding parameter corresponding to a second frame among the consecutive frames, wherein the second frame is adjacent to the first frame;
an encoding unit which generates at least one interpolated parameter based on the first encoding parameter and the second encoding parameter; and
a formatter which generates a bit stream comprising the first encoding parameter, the second encoding parameter, and the at least one interpolated parameter.

14. The encoding apparatus of claim 13, wherein the at least one interpolated parameter is an encoding parameter used to generate at least one interpolated frame located between a third frame decoded based on the first encoding parameter and a fourth frame decoded based on the second encoding parameter.

15. The encoding apparatus of claim 14, wherein the encoding unit generates the at least one interpolated parameter based on a value obtained by summing a first predetermined value obtained by multiplying a first weight and the first encoding parameter and a second predetermined value obtained by multiplying a second weight and the second encoding parameter.

16. The encoding apparatus of claim 15, wherein the first weight is inversely proportional to the second weight, and a sum of the first weight and the second weight is 1.

17. A decoding apparatus comprising:
a de-formatter which receives a bit stream comprising a first encoding parameter, a second encoding parameter, and at least one interpolated parameter, and de-formats and outputs the bit stream;
a decoding unit which extracts the first encoding parameter, the second encoding parameter, and the at least one interpolated parameter from the bit stream; and
a synthesis filer bank which generates a first frame and a second frame based on the first encoding parameter and the second encoding parameter, and generates at least one interpolated frame located between the first frame and the second frame based on the at least one interpolated parameter.

18. The decoding apparatus of claim 17, wherein the first encoding parameter, the second encoding parameter, and the at least one interpolated parameter are multi-channel parameters.

19. The decoding apparatus of claim 17, further comprising a frame size adjusting unit which adjusts a size of a synthesis window according to the number of the at least one interpolated parameter.

20. The decoding apparatus of claim 17, wherein, if the first encoding parameter and the second encoding parameter are generated based on an analysis window having a length L, and the number of the at least one interpolated parameter is 1, the synthesis filer bank applies the synthesis window having the size of L/2 and generates the at least one interpolated frame.
